(19) United States
(12) Patent Application Publication
(10) Pub. No.: US 2010/0250729 A1
(43) Pub. Date: Sep. 30, 2010

(54) Method and System For Providing Access To Metadata Of A Network Accessible Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/413,855

(22) Filed: Mar. 30, 2009

(51) Int. Cl. G06F 15/173

(52) U.S. Cl. 709/224; 709/225

(57) ABSTRACT

Methods, systems and computer program products are described for providing access to metadata of a network accessible resource, where the system includes a content handler component configured to receive request information identifying a matching condition and identifying a metadata-schema domain in a metadata-schema domain space. The metadata-schema domain includes a network domain of a schema provider node providing access to a metadata-schema defining metadata of a network accessible resource. A message formatter component is configured to generate a metadata access request identifying the metadata-schema domain and identifying the matching condition, and a content manager component is configured to send, based on the identified metadata-schema domain, the metadata access request to a metadata repository node representing a metadata-schema domain at least partially including the metadata-schema domain identified in the request.

### RELATED APPLICATIONS

This application is related to commonly owned U.S. patent application No. ______, titled “Methods, Systems, And Computer Program Products for Providing Access to Metadata for an Identified Resource”, filed on Mar. 30, 2009, the entire disclosure of which is hereby incorporated by reference herein.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Most web accessible resources are associated with a schema that can define one or more of a resource's format, structure, vocabulary, and/or semantics, among other things. HTTP, for example, has a schema defined by the World Wide Web Consortium (W3C) specifying, among other things, valid tags, the structure of valid HTTP documents, and attributes associated with tags. In fact, HTTP documents and most other markup based resources, e.g., XML based resources, can include the schema for the resource and/or a reference to the schema in the resource. Alternatively, the schema can be provided with the resource. Non-text resources, such as images, can also have schemas, such as EXIF and TIFF, defining their format and content. Similarly, other media types including executable media types, such as Javascript resources and/or Java resources, can have schemas defining their format and content.

In some cases, a resource can include data that is related to the information in the resource. Such data is typically referred to as metadata. For example, metadata related to a digital image can describe the capture settings for the image, and metadata related to a digital music file can be a song title and artist name. Metadata can be included in a resource, and/or can be included in or can be a separate resource from the resource to which the metadata is related.

In some resources, data can be explicitly identified as metadata. For example, a <meta> tag in an HTML document identifies the data included in the tag as metadata for the including HTML document. The following exemplary use of a <meta> element identifies an author of a document that includes and/or references the element.

<meta name=“author” content=“John Jones”/>

EXIF files include tag locations for storing metadata associated with an image included in an EXIF file. In other situations, whether data is metadata with respect to a resource, or a portion of the resource, is configurable and subject to perspective and judgment. Thus, a picture in a web page with descriptive text can be considered metadata for the text. Alternatively, the text can be considered metadata for the picture. Finally, both can be considered metadata for some other resource. When data is defined to be and/or is used as metadata with respect to a resource, it is metadata.

Identifying a schema for validating a data object such as a specific resource is currently performed by including a locator, e.g., a Uniform Resource Locator (URL), for the schema in the data object. Given a schema locator, locating information conforming to the schema is very difficult, but possible using ad hoc methods designed for individual schemas, by discovering the data, for example, by a “bot”.

Nonetheless, the collection and location of metadata has been and remains a long-standing problem. For instance, metadata collection is difficult because such collection typically requires human data entry. Moreover, even if collected, the locating of collected metadata is difficult because few accessible repositories, beyond standard web search engines, exist. Furthermore, existing instances of metadata are scattered throughout the Internet and although they can be detected by a variety of programs, those programs do not and/or cannot communicate with each other.

### SUMMARY

Methods, systems and computer program products are described for providing access to metadata of a network accessible resource. The methods, systems, and computer program products provide a generalized means for accessing metadata of a network accessible resource based on a metadata-schema domain that includes a network domain of a schema provider node providing access to a schema defining the metadata of the network accessible resource. In an aspect, at least a portion of the metadata or a locator for the metadata is used for providing access to metadata of the network accessible resource.

In an aspect, a method and a computer readable medium storing a computer program, executable by a machine, for providing access to metadata of a network accessible resource includes and comprises executable instructions for receiving request information identifying a matching condition and identifying a metadata-schema domain in a metadata-schema domain space, wherein the metadata-schema domain includes a network domain of a schema provider node providing access to a metadata-schema defining metadata of a network accessible resource. A metadata access request identifying the metadata-schema domain and identifying the matching condition is generated and sent, based on the identified metadata-schema domain, to a metadata repository node representing a metadata-schema domain at least partially including the identified metadata-schema domain. The metadata repository node is configured to maintain an association between metadata and the network accessible resource, and is configured to process the request to provide access to at least a portion of the association based on an evaluation of the matching condition.

In another aspect of the subject matter disclosed herein, a method and a computer readable medium storing a computer program, executable by a machine, for providing access to metadata of a network accessible resource includes and comprises executable instructions for receiving, by a metadata repository node representing a metadata-schema domain in a metadata-schema domain space, a metadata access request identifying a matching condition and a metadata-schema domain that includes a network domain of a schema provider node providing access to a metadata schema defining metadata of a network accessible resource. The method also includes determining that the metadata-schema domain identified in the request is at least partially included in the metadata-schema domain represented by the metadata repository node and processing, by the metadata repository node, the metadata access request in response to determining that the identified metadata-schema domain is at least partially included in the metadata-schema domain represented by the metadata repository node. The processing can include providing access to at least a portion of an association between metadata and the network accessible resource based on an evaluation of the matching condition.

In another aspect of the subject matter disclosed herein, a system for providing access to metadata of a network accessible resource includes a content handler component configured to receive request information identifying a matching condition and identifying a metadata-schema domain in a metadata-schema domain space, wherein the metadata-schema domain includes a network domain of a schema provider node providing access to a schema defining metadata of a network accessible resource. A message formatter component is configured to generate a metadata access request identifying the metadata-schema domain and identifying the matching condition, and a content manager component is configured to send, based on the identified metadata-schema domain, the metadata access request to a metadata repository node representing a metadata-schema domain at least partially including the identified metadata-schema domain.

In another aspect of the subject matter disclosed herein, a system for providing access to metadata of a network accessible resource includes a routing layer component in a metadata repository node representing a metadata-schema domain in a metadata-schema domain space. The routing layer is configured to receive a metadata access request identifying a metadata-schema domain that includes a network domain of a schema provider node providing access to a metadata schema defining metadata of a network accessible resource, and identifying a matching condition. The system also includes a domain manager component configured to determine that the metadata-schema domain identified in the request is at least partially included in the metadata-schema domain represented by the metadata repository node and a processing agent component in the metadata repository node configured to process the metadata access request in response to determining that the identified metadata-schema domain is at least partially included in the metadata-schema domain represented by the metadata repository node. The processing includes providing access to at least a portion of an association between metadata and the network accessible resource based on an evaluation of the matching condition.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 is a block diagram illustrating an exemplary hardware device in which the subject matter may be implemented;

FIG. 2 is a flow diagram illustrating a method for providing access to metadata of a network accessible resource according to an exemplary embodiment;

FIG. 3 is a block diagram illustrating a system for providing access to metadata of a network accessible resource according to an exemplary embodiment;

FIG. 4 is a block diagram illustrating another system for providing access to metadata of a network accessible resource according to another exemplary embodiment;

FIG. 5 is a block diagram illustrating another system for providing access to metadata of a network accessible resource according to yet another exemplary embodiment;

FIG. 6 illustrates a network in which a system for providing access to metadata of a network accessible resource can be implemented;

FIG. 7 illustrates another network in which a system for providing access to metadata of a network accessible resource can be implemented;

FIG. 8 is a flow diagram illustrating another method for providing access to metadata of a network accessible resource according to another exemplary embodiment;

FIG. 9 is a block diagram illustrating a system for performing the method of FIG. 8 according to an exemplary embodiment; and

FIG. 10 is a block diagram illustrating a system for providing access to metadata of a network accessible resource according to another exemplary embodiment.

### DETAILED DESCRIPTION

The subject matter presented herein provides for accessing metadata of a network accessible resource based on an identified metadata-schema domain of a metadata-schema defining the metadata of the network accessible resource. The metadata-schema can be accessed using a schema locator that identifies a network domain of a network node providing access to the schema. The network domain is included in the metadata-schema domain. According to an embodiment, request information is received and identifies a matching condition and identifies a metadata-schema domain in a metadata-schema domain space. The metadata-schema domain includes a network domain of a schema provider node providing access to a metadata-schema defining metadata of a network accessible resource. A metadata access request is generated, and, in an embodiment, identifies the metadata-schema domain and the matching condition. The metadata access request is then sent to a metadata repository node representing a metadata-schema domain at least partially including the metadata-schema domain identified in the metadata access request.

In an embodiment, the metadata repository node is configured to maintain an association between metadata and the network accessible resource. In response to receiving the metadata access request, the metadata repository node is configured, in an embodiment, to process the metadata access request to provide access to at least a portion of an association based on the matching condition. For example, the metadata repository node can be configured, in an embodiment, to access an association based on an evaluation of the matching condition, and to provide a locator identifying a host for accessing the metadata related to the accessed association. Alternatively or additionally, at least a portion of the metadata can be provided. In either or both cases, metadata of the network accessible resource can be accessed based on the matching condition and the identified metadata-schema domain, which itself can be based on the schema's locator.

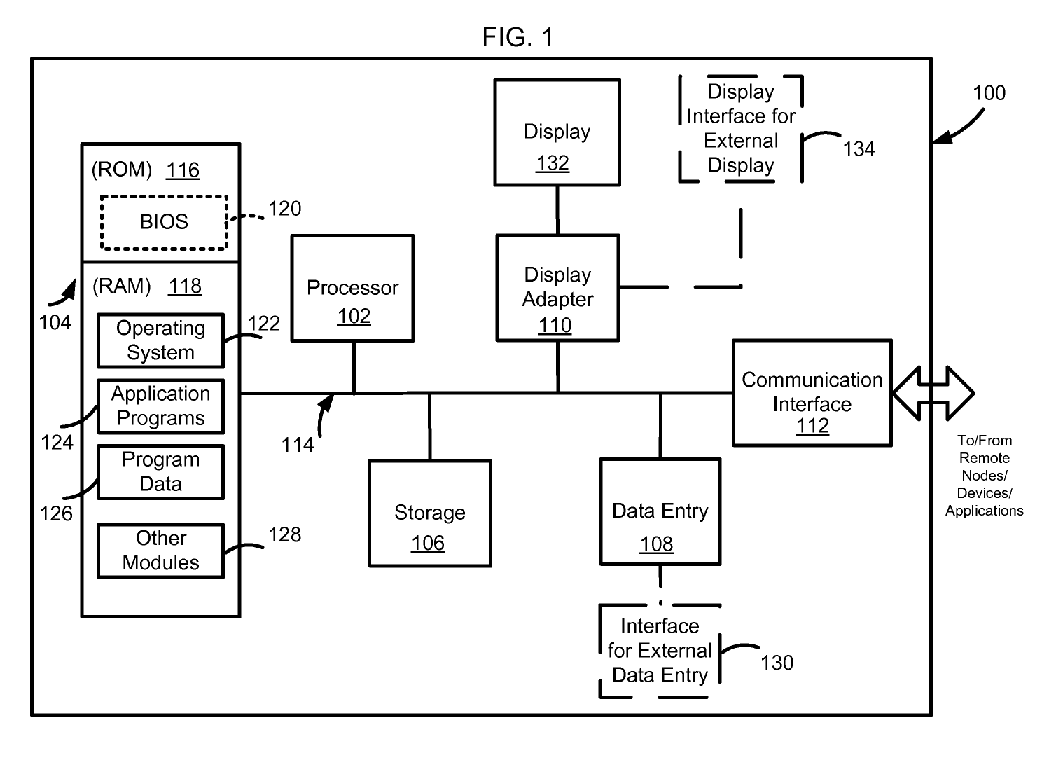

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

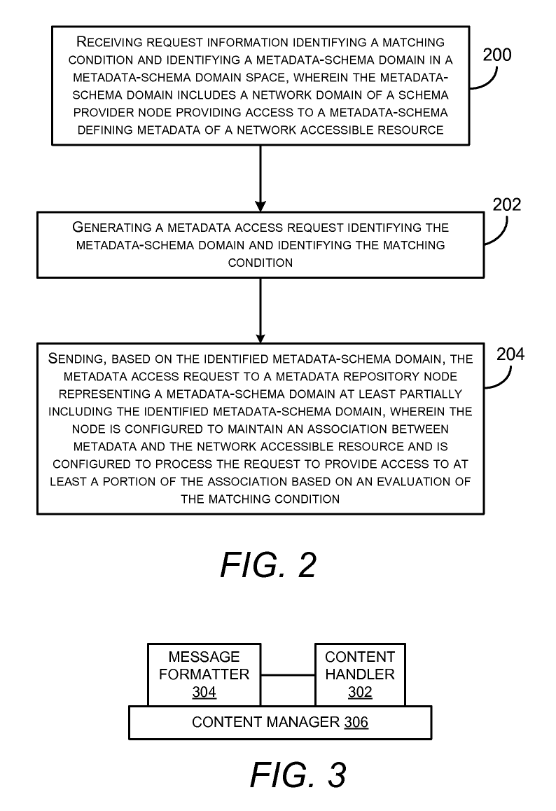

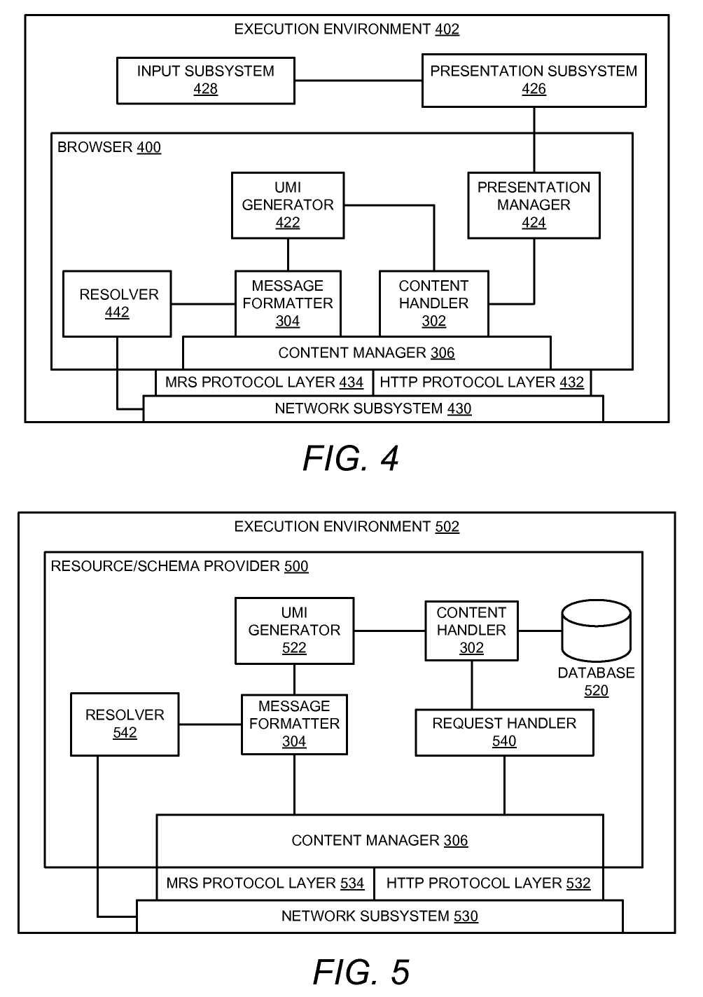

Referring now to FIG. 2, a flow diagram is presented illustrating a method for providing access to metadata of a network accessible resource according to an exemplary embodiment. FIGS. 3, 4 and 5 are block diagrams illustrating systems for providing access to metadata of a network accessible resource according to embodiments of the subject matter described herein. In particular, FIG. 3 illustrates an arrangement of components configured for providing access to metadata of a network accessible resource, while FIG. 4 and FIG. 5 illustrate the components of FIG. 3 and/or their analogs adapted for operation in execution environments provided by nodes for providing access to metadata of a network accessible resource. The method illustrated in FIG. 2 can be carried out by, for example, at least some of the components in each of the exemplary arrangements of components illustrated in FIGS. 3, 4 and 5. The arrangement of components in FIG. 4 and FIG. 5 may be implemented by some or all of the components of the hardware device 100 of FIG. 1.

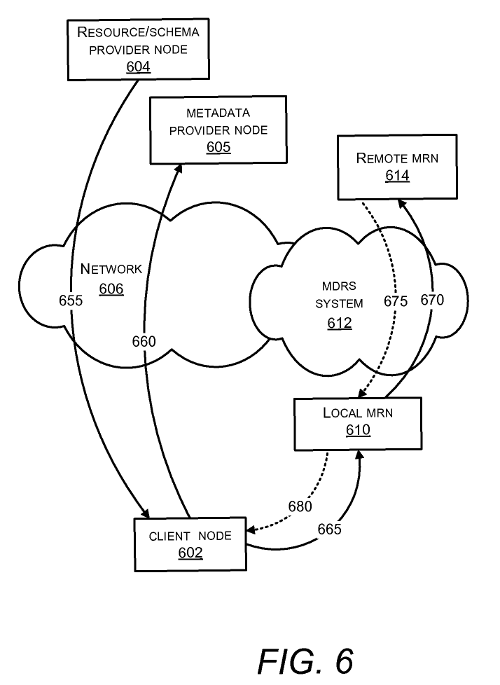

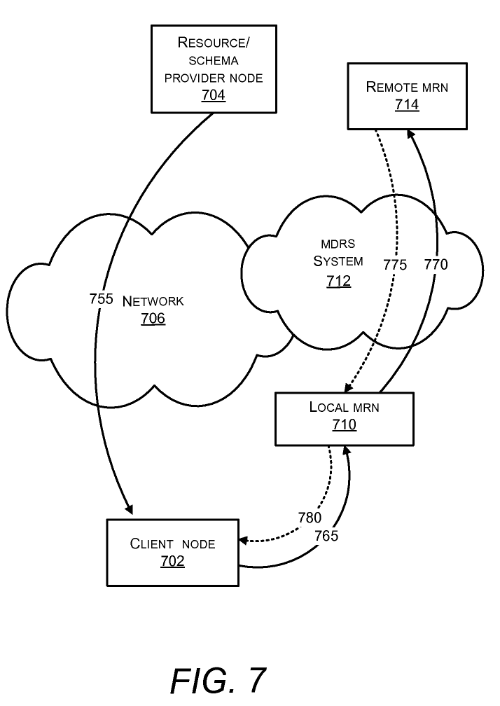

FIG. 3 illustrates components that are configured to operate within an execution environment hosted by a node and/or multiple nodes, as in a distributed execution environment. For example, in FIG. 6 and FIG. 7, which each illustrate a plurality of nodes communicatively coupled to one another via a network 606, 706 such as the Internet, client nodes 602, 702, resource/schema provider nodes 504, 604, and metadata provider nodes 605 can be configured to provide respective execution environments configured to support the operation of the components illustrated in FIG. 3 and/or their analogs. Exemplary nodes can include desktop computers, servers, networking nodes, notebook computers, PDAs, mobile phones, digital image capture devices, and the like. For example, in an embodiment, the resource/schema provider node 504, 604 can be an application server or a publish-subscribe service, such as a presence service.

Illustrated in FIG. 4 is a browser 400 including the components illustrated in FIG. 3 adapted for operating in an execution environment 402. The execution environment 402, or an analog, can be provided by a node such as the client node 602, 702. Alternatively or additionally, as illustrated in FIG. 5, the components illustrated in FIG. 3 can be adapted for operation in a resource/schema provider service 500 in an execution environment 502 provided by the resource/schema provider node 504, 604, or the metadata provider node 605.

With reference to FIG. 2, in block 200, request information identifying a matching condition and identifying a metadata-schema domain in a metadata-schema domain space is received. The metadata-schema domain includes a network domain of a schema provider node providing access to a metadata-schema defining metadata of a network accessible resource. In an embodiment, a system for providing access to metadata of a network accessible resource includes means for receiving request information identifying a matching condition and identifying a metadata-schema domain. For example, FIG. 3 illustrates a content handler component 302 configured to receive request information identifying a matching condition and identifying a metadata-schema domain in a metadata-schema domain space, where the metadata-schema domain includes a network domain of a schema provider node providing access to a metadata-schema defining metadata of a network accessible resource.

According to an embodiment, the content handler component 302 can receive the request information included in configuration information of a browser 400 or a resource/schema provider 500, in the content of a resource, such as a link in a web page, in a resource identified by a resource locator, and/or in a message received along with at least a portion of a resource. In an embodiment, the matching condition can identify the metadata-schema domain, and/or the metadata-schema domain can be identified independent of the matching condition.

The request information can include a schema locator, e.g., a schema URL, that identifies the metadata-schema domain. For example, the schema locator can include an identifier identifying the metadata-schema domain. The schema locator, in an embodiment, can be a URL for the metadata-schema and/or for the network accessible resource to which the metadata is related. In another embodiment, the content handler component 302 can receive a Uniform Resource Name (URN) identifying the metadata-schema and can determine the schema locator of the metadata-schema based on the URN.

For example, the URN can be formatted to specify a resolver URL for accessing a resolver entity configured to resolve the URN. In an embodiment, the syntax of such a URN can be based on a “res-hint” Hypertext Transfer Protocol (HTTP) header defined in “WIRE—W3 Identifier Resolutions Extensions” by Girod, et al., proposed for HTTP in IETF draft-griod-w3-id-res-ext-00.txt. The hint, as specified in a res-hint header, can include the location and a protocol of a resolver (see, “URN Resolution Using WIRE” by Girod, et al., in IETF draft-girod-URN-res-using-wire-00.text) configured to determine a URL based on the URN.

In an exemplary embodiment, the content handler component 302 can be configured to receive the request information in a response to a request, in a notification associated with a subscription, in an unsolicited asynchronous message, and/or via input from a user or another component. In addition to identifying the metadata-schema domain, the request information can identify a schema provider that provides access to the identified schema as well as other resources. The schema provider can be hosted by a remote node or by a node on which the content handler component 302 is operating. In the latter case, the schema locator can be used to access a schema stored locally, for example, via a URI with a “file” schema, and/or stored in a database record, for example, via a URN scheme such as an ISBN URN scheme.

According to an embodiment, the components illustrated in FIG. 3, including the content handler component 302, can be adapted to operate in a browser 400 in an execution environment 402 provided by a node, such as the client node, e.g., 602, 702. Alternatively or additionally, the content handler component 302 can also be adapted to operate in a resource/schema provider service 500 in an execution environment 502 provided by a node, such as the resource/schema provider node 504, 604, or the metadata provider node 605.

The content handler component 302 can be configured to process a particular type, e.g., MIME type, of content. Accordingly, while a single content handler component 302 is illustrated in FIG. 4 and FIG. 5, the browser 400 and the resource/schema provider service 500 can support and include more than one content handler component 302 to process different data types. For example, a video stream content handler component 302 can be provided and configured to process a particular type of video data corresponding to a video stream, while an image content handler component 302 can also be provided and configured to process image data formats identifiable by MIME type. Additionally or alternatively, a content handler component 302 can be configured to process more than one type of markup language based data.

In the browser 400 and in the resource/schema provider service 500, the request information can be received as incoming data. In an embodiment, the request information can be received in a message transmitted over the network 606, 706 and received by a client node 602, a schema provider node 604, and/or a metadata provider node 605. For example, in FIG. 6, a message 655 from a first schema provider node 604 is received by the client node 602, and a message 660 from the client node 602 is received by the metadata provider node 605. The message 655, 660 can be a response to a request, a notification associated with a subscription, and/or an unsolicited asynchronous message.

The incoming message can be received by the content handler component 302 via a network subsystem 430, 530. In an embodiment, the message is received via a protocol layer of the network subsystem 430, 530, or via an application protocol layer, or other higher protocol layer, as illustrated by an exemplary HTTP protocol layer 432, 532 among many possible standard and proprietary protocol layers. For example, the message can be received via an application protocol layer supporting a protocol specifically for communicating with and/or within a Metadata Repository Service System (MDRS System) 612, 712. A Metadata Repository Service (MRS) protocol layer 434, 534 can be provided and configured to support communications with a Metadata Repository Node (MRN) 610, 614, 710, 714. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP).

In the browser 400, the content handler component 302 can receive the message via the network subsystem 430 and the content manager component 306 in an embodiment. The content manager component 306 can access at least a portion of the request information included in a received message, or in a message to be sent, and parse the message into elements of the type(s) supported by the content handler component 302.

In the resource/schema provider service 500, the content handler component 302 can receive the message via a content manager component 306 and a request handler 540. In an embodiment, the content manager component 306 is configured to access at least a portion of the request information included in the received message, or in a message to be sent, and separate the message into message portions, such as a message header and content portions, when content is present. The content manager component 306 can detect a message type, e,g, HTTP GET, HTTP POST, a publish-subscribe publish command, or a subscribe command, and provide the message content to a request handler 540. The request handler 540 can be configured to provide message content to one or more content handlers 302 according to the type of the content. The request information can be included in the payload portion of a message or in a header or trailer portion of a message. When the request information is included in a message header and/or trailer, the request handler 540 and/or content manager component 306 can be configured to receive the request information.

In another embodiment, the request information can be received and processed as outgoing data. When the data is outgoing, it can be sent as a message 655, 755 transmitted over the network 606, 706 by the resource/schema provider node 504, 604, or as a message 660 transmitted over the network 606 by a client node 602. In an embodiment, the message can include and/or reference the request information, and can be transmitted via the sending node's network subsystem 430, 530.

In an embodiment, the network subsystem 430, 530 receives a message or portions of a message generated by the content handler component 302. The message can be provided by the content handler component 302 to a message formatter component 304 configured to build a message compatible with a protocol for transmitting the message. The message formatter 304 can be configured to interoperate directly with the protocol layer of the network subsystem 430, 530 or with an application protocol layer, as described above and illustrated by the exemplary HTTP protocol layer 432, 532 and the MRS protocol layer 434, 534.

Request information received by a content handler component 302 for including, and/or referencing, in an outgoing message can be received by the content handler component 302 from any of a variety of sources. For example, in the browser 400, the content handler component 302 can receive the request information via a presentation manager 424 of the browser 400. The presentation manager 424 can be configured to interoperate with a presentation subsystem 426 in the execution environment 402 to present a graphical user interface (GUI) for the browser 400. Input, such as user input, can be received from an input device (not shown) by an input subsystem 428 of the execution environment 402. The input can be received in correspondence with a widget presented as part of the browser GUI by the presentation subsystem 426 interoperating with a display device (not shown) as directed by the presentation manager 424 directed by one or more content handler components 402.

The received input can correspond to a URL entered into a location bar widget of the browser GUI or a link presented in a web page in a page widget or tab widget of the browser GUI. An indication of the input can be provided to the presentation subsystem 426, which is configured to determine an application or other component to receive the input based on the correspondence between the input and the state of the presentation. The presentation subsystem 426 can determine that the input information is to be provided to the presentation manager 424 of the browser 400. The presentation manager 424 can be configured to determine one or more components configured to process the input such as the content handler component 302 controlling the presentation of a portion of the browser GUI corresponding to the input.

In another embodiment, the request information can be received from a data store. For example, the browser 400 can access a bookmark including a matching condition from a locally accessible data store (not shown). Similarly, the resource/schema provider service 500 can store data that can include and/or reference request information in a locally accessible data store 520. Such data can include media content, web pages, page templates, and/or scripts.

Accordingly, request information can be received in processing an incoming message, in building and sending an outgoing message, and/or can be received from a non-network source, such as a user and/or another component operating in the same execution environment of the component receiving the request information. Content handler components 302 have been described as exemplary components that can be configured to receive such information, but any of a number of other components can be configured to receive request information including components illustrated in FIGS. 3, 4, and 5, and components not illustrated or described in this document.

Referring again to FIG. 2, in block 202, a metadata access request identifying the metadata-schema domain and identifying the matching condition is generated. A system for providing access to metadata of a network accessible resource includes means for generating a metadata access request identifying the metadata-schema domain and identifying the matching condition. For example, FIG. 3 illustrates a message formatter component 304 configured to generate a metadata access request identifying the metadata-schema domain and identifying the matching condition.

According to an embodiment, the content handler component 302 and/or any other component receiving the request information can invoke the message formatter component 304 to generate the metadata access request in response to receiving a metadata-schema domain identifier included in a schema locator and/or in response to another associated event such as user input event, a timer event, a network event, and/or any event detectable within an execution environment. For example, in the browser 400, the content handler component 302 can receive a schema locator in a resource, such as a web page or a media object, along with an indication to access metadata for the received resource. The browser 400 can be instructed via configuration and/or received input to access the metadata for the received resource. Analogously, the resource/schema provider service 500 can receive a metadata-schema domain identifier included in a schema locator in a message requesting a resource and/or in a message including a resource, e.g., an HTTP POST message. The resource/schema provider service 500 can be instructed via configuration and/or received input to access the metadata for the identified resource. As used in this description, accessing the metadata includes, but is not limited to, retrieving the metadata and/or an identifier for the metadata, storing and/or reading the metadata, and updating the metadata.

The message formatter component 304 is configured, in an embodiment, to generate the metadata access request according to a protocol specification supported by the protocol layer operatively coupled to the message formatter 304, such as the HTTP protocol layer 432, 532 or any other suitable protocol. In other embodiments, the content handler component 302, the content manager component 306, an application protocol layer, and/or a component of the network subsystem 430, 530 can interoperate with the message formatter component 304.

In an embodiment, the metadata access request generated by the message formatter component 304 can include a URI that identifies the metadata-schema domain of the schema to which associated metadata conforms. The URI, referred to herein as a Universal Metadata Identifier (UMI), can be based on the schema locator of the metadata-schema and/or a resource locator of the network accessible resource. The schema or resource locator can be a URL or other type of Uniform Resource Identifier (URI). In the browser 400 and in the resource/schema provider service 500, a UMI generator component 422, 522 can be invoked by the content handler component 302 or the message formatter component 304 to generate the UMI that identifies the metadata-schema domain.

In an embodiment, the UMI generated by the UMI generator component 422, 522 can be used as a parameter for routing a message to an MRN representing a metadata-schema domain that at least partially includes the domain identified by the UMI. The UMI can be viewed as a URN in that it doesn't directly identify the MRN and/or it can be viewed as a new type of routable URL that locates the MRN when used as a routing parameter. The UMI is based on the schema locator or resource locator, e.g., the URL, of the metadata-schema or resource, respectively. In one embodiment, the UMI includes at least a portion of the URL. For example, the UMI includes at least the metadata-schema domain identifier included in the schema locator. In another embodiment, the UMI includes the entire URL. Accordingly, the UMI, when used as a traditional URL, identifies the resource/schema provider and/or the location of the resource/schema provider node 504, 604, but when used as a URN and/or routable URL, can identify an association between metadata and the network accessible resource.

The UMI generator component 422, 522 can generate the UMI, in an embodiment, based on a lookup performed locally, a formula, and/or based on a template. In an embodiment, the template can be used to generate the UMI based on the metadata-schema domain identifier.

Referring again to FIG. 2 in block 204, once generated, the metadata access request is sent, based on the identified metadata-schema domain, to a metadata repository node (MRN) representing a metadata-schema domain at least partially including the metadata-schema domain identified in the metadata access request. In an embodiment, the MRN is configured to maintain an association between metadata and a network accessible resource, and is configured to process the request to provide access to at least a portion of the association based on an evaluation of the matching condition. A system for providing access to metadata of a network accessible resource includes means for sending the metadata access request to an MRN representing a metadata-schema domain at least partially including the metadata-schema domain identified in the metadata access request. For example, FIG. 3 illustrates a content manager component 306 configured to send, based on the identified metadata-schema domain, the metadata access request to an MRN representing a metadata-schema domain at least partially including the metadata-schema domain identified in the metadata access request, where the MRN is configured to maintain an association between metadata and a network accessible resource, and is configured to process the request to provide access to at least a portion of the association based on an evaluation of the matching condition.

According to an embodiment, the MRN representing a metadata-schema domain provides an execution environment for hosting a Metadata Repository Service (MRS). The MRS can be a centralized service hosted by an MRN or a cluster of MRNs providing an MDRS System in an embodiment. Alternatively, the MRS can be hosted by MRNs included in a distributed collection of nodes representing various metadata-schema domains in the MDRS System in another embodiment. In an embodiment, the MRN can be a repository node described in a pending patent application entitled “Method and System For Managing Metadata Associated With A Resource,” patent application Ser. No. 12/273,003 (Attorney Docket No. 1542/US), filed Nov. 18, 2008, assigned to the assignee of the present patent application and herein incorporated by reference in its entirety.

The metadata access request can be received by a routing node configured to route the message, based on the identified metadata-schema domain, to the MRN representing the metadata-schema domain at least partially including the identified metadata-schema domain. The routing node can be associated with one or more network identifiers of one or more network interfaces, none of which include the metadata-schema domain identifier. In an embodiment, the message formatter component 304 can be configured to determine and/or to provide a network address of the routing node. In one embodiment, the network address of the routing node can be provided in configuration data of a node in which the message formatter component 304 is operating.

Alternatively or additionally, the network address can be received from user input, received in a resource, received when the metadata access request is generated, received from a remote node, in response to a request, and/or generated based on at least one of a configured template, an identifier of a schema of the metadata, an identifier of a resource, and an identifier of the metadata. The network address of the routing node can be received, in an embodiment, over the network from a management server, such as a Dynamic Host Configuration Protocol (DHCP) server. Alternatively, the network address provided or determined can be that of the MRN representing the metadata-schema domain at least partially including the identified metadata-schema domain. In this embodiment, the message formatter component 304 can be configured to send the metadata access request to the MRN, where the request can include the network address as a destination address for the request.

According to another embodiment, the browser 400 and the resource/schema provider service 500 can include a resolver 442, 542 configured to generate a query for an identifier, e.g., a URL, of the MRN representing the metadata-schema domain at least partially including the identified metadata-schema domain. The message formatter component 304 and/or the UMI generator component 422, 522 can be configured to invoke, and to provide the UMI to, the resolver 442, 542. In an embodiment, a query including the UMI can be sent to a resolving service (not shown), via the network subsystem 430, 530, using any protocol defined for interoperating with the resolving service. In an embodiment, the protocol can be analogous to a Domain Name System (DNS) protocol and/or a Lightweight Directory Access Protocol (LDAP).

According to an embodiment, the metadata access request generated by the message formatter component 304 is provided to the content manager component 306, which determines a protocol component compatible with the request. The request can be transmitted using any protocol supported by the MRS operating in an execution environment provided by an MRN, such as a local MRN 610, 710, included in a network of MRNs included in the MDRS System 612, 712. For example, the request can be transmitted using an MRS protocol supported by the MRS protocol layer 434, 534. The compatible protocol layer, e.g., 434, 534, sends the request as a whole or in parts via the network subsystem 430, 530 over the network to the MRN 610, 710.

For example, referring to FIG. 6 and FIG. 7, the content manager component 306 operating in the client node 602, 702 is configured to send the metadata access request 665, 765 to an MRN, e.g., the local MRN 610, 710, in the MDRS system 612, 712. Similarly, the content manager component 306 operating in the resource/schema provider node 504, 604 or in the metadata provider node 605 can be configured to send the request to an MRN 610, 710. As stated above, the network address of the MRN 610, 710 can be determined in several ways. For example, it can be provided in the configuration data of the client node 602, 702, provided by a user, received from a remote node, and/or generated.

According to an embodiment, each MRN 610, 614, 710, 714 represents a metadata-schema domain and can be configured to maintain associations between conforming metadata and network accessible resources. In an embodiment, an MRN, e.g., 614, can be configured to maintain a plurality of records representing associations between metadata and the network accessible resources. An association record can include an accessor for accessing the metadata and the network accessible resource in the association. In an embodiment, the accessor can include a metadata locator, such as a URL, for accessing the metadata. Alternatively or additionally, the accessor can be an instance of metadata.

In an embodiment, when the request is received by the MRN, e.g., 610, 710, it can determine whether the metadata-schema domain identified in the metadata access request is at least partially included in the metadata-schema domain of the MRN 610, 710. When the identified metadata-schema domain is not at least partially included in the metadata-schema domain represented by the receiving MRN 610, 710, it can route the request 670, 770, based on the metadata-schema domain identifier, to another MRN 614, 714 in the MDRS System 612, 712 that represents a metadata-schema domain that at least partially includes the metadata-schema domain identified in the metadata access request.

When the identified metadata-schema domain is at least partially included in the metadata-schema domain represented by the MRN 610, 710, a metadata access response 680, 780 can be sent to the client node 602, 702 in an embodiment. Alternatively, when the MRN representing a matching metadata-schema domain is a remote MRN 614, 714, the remote MRN 614, 714 can send a metadata access response 675, 775 to the local MRN 610, 710 for routing to the client node 602, 702. Depending on the circumstances, the metadata access response 675, 680, 775, 780 can be required or optional. For example, when the metadata access request 665, 765 requests a representation of metadata for presentation, a metadata access response 675, 680, 775, 780 is required. Alternatively, when the metadata access request 665, 765 includes a command and/or other indication for accessing and operating on the metadata, a metadata access response 675, 680, 775, 780 is not required, but can be sent when supported by the protocol in use. If, for example, the protocol used supports one-way communication, such as an asynchronous protocol, a response can be optional.

According to an embodiment, the metadata access response 675, 680, 775, 780 can include an accessor for accessing the metadata and the network accessible resource in the accessed association. For example, referring to FIG. 6, the accessor can include an identifier, such as a URL, that identifies the metadata provider node 605 as a provider for the metadata. The content handler component 302 in the client node 602 can be configured to receive the metadata access response 680 including the identifier for accessing the metadata. The identifier can be passed to the message formatter component 304 which uses the content manager component 306 to send a message 660 addressed to the metadata provider node 605 based on the identifier.

In another embodiment when the MRN 710, 714 maintains an instance of metadata, the metadata access response, e.g., 775, 780, can include at least a portion of the metadata. Alternatively or additionally, the metadata access response 775, 780 can include an indication of the result of the access of the metadata and/or can complete the access by the client node 702 processing at least a portion of the metadata returned in the metadata access response 775, 780. In an embodiment the content handler component 302 in the client node 702 can also be configured to receive the metadata access response 775, 780 including at least a portion of the metadata.

In an embodiment, the MRN 610, 710 can return metadata information included in all associations that match the identified metadata-schema domain. A client node 602, 702 receiving this information can be configured to identify metadata satisfying the matching condition. An MRN 610, 614 that maintains associations including an identifier of matching metadata can send a response 675, 680 providing locators for at least a portion of the matching metadata.

While exemplary identifiers above, such as URIs, have been based on names from a naming domain, the identifier of a metadata-schema domain can also be based on a network address or any suitable naming system that can be segmented into domains. For example, a schema identifier can be a geospatial identifier, such as a network address and/or a symbolic name.

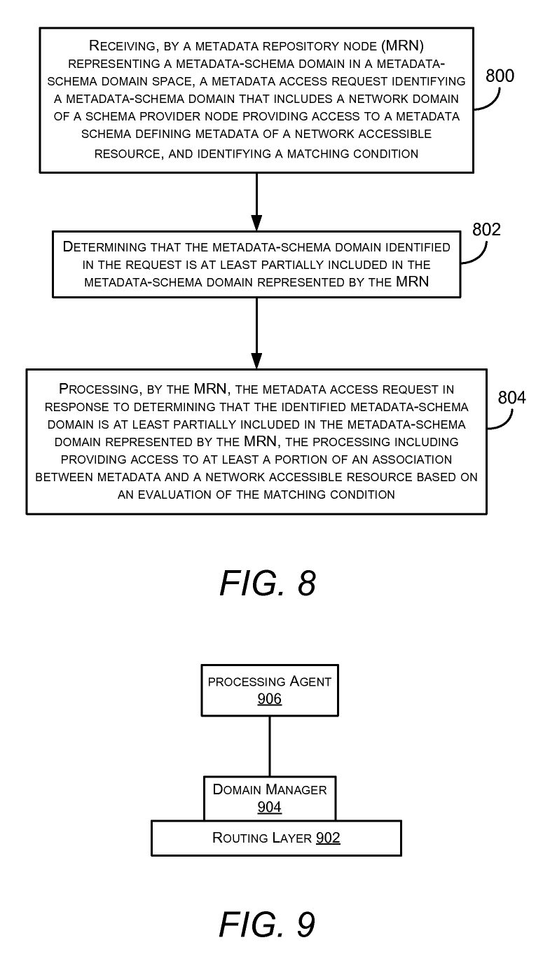

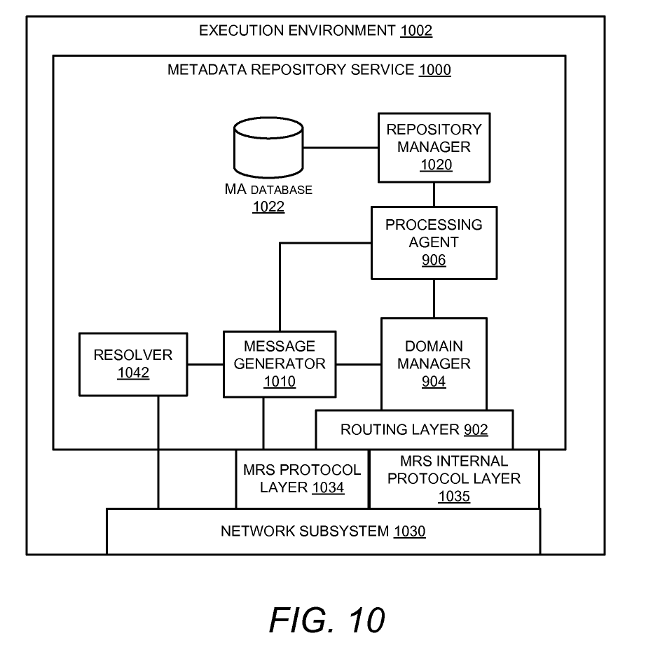

FIG. 8 is a flow diagram illustrating a method for providing access to metadata of a network accessible resource according to another aspect of the subject matter described herein. In particular, the method is from the perspective of the MRN or an analog. FIGS. 9 and 10 are block diagrams illustrating systems for providing access to metadata of a network accessible resource according to embodiments of the subject matter described herein. In particular, FIG. 9 illustrates an arrangement of components configured for providing access to metadata of a network accessible resource, while FIG. 10 illustrates the components of FIG. 9 and/or their analogs adapted for operation in an execution environment provided by one or more nodes for providing access to metadata of a network accessible resource. The method illustrated in FIG. 8 can be carried out by, for example, at least some of the components in each of the exemplary arrangements of components illustrated in FIGS. 9 and 10. For example, Illustrated in FIG. 10 is a metadata repository service (MRS) 1000 including the components illustrated in FIG. 9 adapted for operating in an execution environment 1002 provided by a node such as the MRN 610, 614, 710, 714.

Referring to FIG. 8, in block 800, a metadata access request is received by an MRN representing a metadata-schema domain in a metadata-schema domain space. In an embodiment, the metadata access request identifies a metadata-schema domain that includes a network domain of a schema provider node providing access to a metadata schema defining metadata of a network accessible resource, and identifies a matching condition. According to an exemplary embodiment, a system for providing access to metadata of a network accessible resource includes means for receiving, by an MRN representing a metadata-schema domain in a metadata-schema domain space, a metadata access request. For example, FIG. 9 illustrates a routing layer component 902 in an MRN representing a metadata-schema domain in a metadata-schema domain space, and configured to receive a metadata access request identifying a matching condition and identifying a metadata-schema domain that includes a network domain of a schema provider node providing access to a metadata schema defining metadata of a network accessible resource.

In an embodiment, the MRN, e.g., 610, 710, can be identified by an identifier in a domain space also including the resource/schema domain and/or the metadata-schema domain. The identifier of the MRN 610, 710 can be in an MRN domain that is not included in either or both of the metadata-schema domain and resource/schema domain.

According to an exemplary embodiment, the metadata access request, e.g., 665, 765, can be received by a routing layer component 902 included in an MRS 1000 operating in an execution environment 1002 provided by an MRN, e.g., 610, 710, representing a metadata-schema domain. In an embodiment, the metadata access request 665, 765, can be received from the client node 602, 702, from the resource/schema provider node 604, 704, or from the metadata provider node 605. In another embodiment, a remote MRN 614, 714 can receive the metadata access request 670, 770 from a sending node 602, 702, 604, 704, 605 via a local MRN 610, 710 as described above.

The metadata access request 665, 765 can be transmitted from the sending node via the network 606, 706 and received by the routing layer component 902 via a network subsystem 1030 and optionally a higher layer protocol, such as an MRS protocol layer 1034 or an MRS Internal protocol layer 1035 provided for communication between MRNs in the MDRS System 612, 712. In an embodiment, the MRS protocol layer 1034 and the MRS Internal protocol layer 1035 can support a single protocol or different protocols. In an embodiment, the received request 665, 765 can be the same metadata access request generated and sent according to the method described in FIG. 1. Accordingly, an exemplary UMI, described above, can be included in the request 665, 765.

Referring again to FIG. 8 the method continues in block 802 by determining that the metadata-schema domain identified in the metadata access request is at least partially included in the metadata-schema domain represented by the MRN. According to an exemplary embodiment, a system for providing access to metadata of a network accessible resource includes means for determining that the metadata-schema domain identified in the metadata access request is at least partially included in the metadata-schema domain represented by the MRN. For example, FIG. 9 illustrates a domain manager component 904 configured to determine that the metadata-schema domain identified in the metadata access request is at least partially included in the metadata-schema domain represented by the MRN.

According to an embodiment, the routing layer component 902, in response to receiving the metadata access request 665, 765, 670, 770 can provide at least a portion of the request to the domain manager component 904 based on an attribute of the request, such as a request type and/or a command code included in the request 665, 765, 670, 770. The domain manager component 904 can be adapted to operate in the MRS 1000 operating in the execution environment 1002 provided by an MRN 610, 614, 710, 714.

The domain manager component 904 can be configured, in an embodiment, to determine whether the metadata-schema domain identified in the metadata access request is at least partially included in the metadata-schema domain represented by the receiving MRN, e.g., 610, 710, by performing a matching algorithm and/or performing a lookup in a table or other storage location for locating a matching entry. For example, the domain manager component 904 can be configured to compare the identifiers of the metadata-schema domain identified in the metadata access request and the metadata-schema domain of the MRN 610, 710, and to determine whether the two identifiers are included in the same domain space, such as a DNS name space or an IP address name space. In an embodiment, the metadata-schema domain represented by the MRN 610, 710 can identify a specific domain or can be expressed as a matching expression, such as a regular expression, allowing any number of metadata-schema domains to match the domain expression.

In an embodiment, matching can include converting one of the metadata-schema domain identifiers from a first domain space into a domain identifier in a second domain space corresponding to the metadata-schema domain space of the other domain identifier, and comparing the domain identifiers. For example, the metadata-schema domain identifier of the metadata-schema domain identified in the request, referred to here as a first domain identifier, can be a name in a naming domain space, or a subnet identifier in a network address domain space. Determining whether the first domain identifier is at least partially included in the metadata-schema domain of the MRN can include mapping the first domain identifier to a domain space corresponding to the domain space of the metadata-schema domain identifier of the metadata-schema domain of the MRN, referred to here as a second domain identifier, and comparing the mapped first domain identifier to the second domain identifier of the MRN.

For instance, if the first domain identifier is included in an IP address name space and identifies a subnet, and the second domain is identified as a domain in a DNS name space, the subnet address of the first domain identifier can be mapped to one or more identifiers in the DNS name space identifying DNS domains. Each of the mapped DNS names can be matched against the second domain identifier to determine whether there is at least an overlap between the nodes in the subnet identified as the first domain and the naming domain identified as the second domain. An identifier from a geospatial identifier domain space that identifies geospatial regions can identify one or both of the domains. Mapping to and/or from a geospatial identifier domain to another type of domain can be performed when required.

Referring again to FIG. 8, in block 804, when the metadata-schema domain identified in the metadata access request is determined to be at least partially included in the metadata-schema domain represented by the receiving MRN, the metadata access request is processed. Such processing includes providing access to at least a portion of an association between metadata and a network accessible resource based on an evaluation of the matching condition. According to an exemplary embodiment, a system for providing access to metadata of a network accessible resource includes means for processing the metadata access request when the identified metadata-schema domain is determined to be at least partially included in the metadata-schema domain represented by the MRN. For example, FIG. 9 illustrates a processing agent component 906 configured to process, by the MRN, the metadata access request in response to determining that the identified metadata-schema domain is at least partially included in the metadata-schema domain represented by the MRN, the processing including providing access to at least a portion of an association between metadata and a network accessible resource based on an evaluation of the matching condition.

When the identified metadata-schema domain is determined to be at least partially included in the metadata-schema domain represented by the MRN, the domain manager component 904 can provide an indication to the processing agent component 906 to this effect. According to an exemplary embodiment, the processing agent component 906 can be configured to process the metadata access request 665, 670, 765, 780 by, for example, locating a storage area for storing a new association between the metadata and the resource, by reading the metadata, by updating at least a portion of the metadata, and/or by deleting at least a portion of the metadata. In addition, the processing agent component 906 can be configured to receive at least a portion of the metadata and/or a metadata locator for accessing the metadata.

For example, in an embodiment, a metadata association (MA) database 1022 in an execution environment 1002 provided by an MRN 610, 614, 710, 714 can store metadata, identifiers of metadata, network accessible resources and/or identifiers of network accessible resources. The MA database 1022 can include a plurality of records representing a metadata association between metadata and network accessible resources. Each record can identify the metadata and the schema from a schema provider having a metadata-schema domain identifier at least partially included in the metadata-schema domain identifier of the MRN 610, 614, 710, 714. Additionally, the record can identify a resource to which the metadata is related. In an embodiment, the record can be associated with an accessor for accessing the metadata and the network accessible resource in the represented metadata association. The accessor can, in an embodiment, include at least a portion of the metadata and/or a metadata locator for accessing the metadata associated with the matching record.

In an embodiment, the processing agent component 906 can invoke, and can provide the matching condition and/or the identified metadata-schema domain identifier to, a repository manager 1006 operatively coupled to the MA database 1022 to determine, based on an evaluation of the matching condition, at least one record matching the matching condition. The repository manager 1006 can query the MA database 1022 for all records matching the matching condition and having metadata, or identifiers of metadata, associated with the metadata-schema domain identified in the metadata access request, and/or having locators of metadata conforming to a schema in the metadata-schema domain identified in the request.

In response to determining the at least one matching record, an accessor associated with the at least one matching record can be returned by the repository manager 1006 to the processing agent component 906 for further processing. As stated above, the accessor can, in an embodiment, include at least a portion of the metadata and/or a metadata locator for accessing the metadata associated with the matching record.

In an embodiment, the processing agent component 906 can be configured to call another component to process the accessor. In another embodiment, the processing agent component 906 can be configured to request a remote node to process the accessor, and/or send a response allowing a receiver of the message to process the accessor. For example, the processing agent component 906 can be figured to invoke a message generator component 1010 that is configured to generate a metadata access response 680, 780, including the retrieved accessor, and to send the response 680, 780 to a receiving node, such as a client node 602, 702 from which the metadata access request was sent.

When the repository manager 1006 fails to determine a matching record, an indication indicating no record was located can be provided to the domain manager component 904. The domain manager component 904 can provide the negative indication to another component, such as the message generator 1010, configured to process messages indicating no matching record is included in the MA database 1022. The message generator 1010 can generate a response message 680, 780 consistent with not locating an association between metadata and a network accessible resource that satisfies the matching condition.

When the domain manager component 904 determines that the identified metadata-schema domain is not at least partially included in the metadata-schema domain represented by the MRN 610, 710, the domain manager component 904 can discard the received metadata access request 665, 765 or can return a response 580, 680 indicating that the MRN 610, 710 does not represent a metadata-schema domain at least partially including the identified metadata-schema domain to the sending node, e.g., the client node 602, 702. Alternatively, the domain manager component 904 can provide for routing the received metadata access request 665, 765 to another MRN, e.g., a remote MRN 614, 716, representing another metadata-schema domain. For example, in an embodiment, the domain manager component 904 can invoke the message generator 1010, which is configured to generate a second message 670, 770 including at least a portion of the metadata access request 665, 765, and to send the second message 670, 770 for routing, based on the identified metadata-schema domain, to a second MRN 614, 716 representing a second metadata-schema domain.

According to an exemplary embodiment, when the second message is to be sent for routing to the second MRN 614, 716, the message generator 1010 is configured to determine a network address of a node configured to route the second message to the second MRN 614, 716. In an embodiment, the message generator 1010 can be configured with the network address of the second MRN 614, 716. In other embodiments, the network address of the second MRN 614, 716 can be received with the metadata access request, received from a resolver service (not shown) in response to a request, and/or received with the sending application. In another alternative, the network address of the second MRN 614, 716 can be generated based on identifiers of the metadata schema, the resource, and/or the metadata.

In an embodiment, the message generator 1010 can invoke a resolver 1042, which can be configured to generate or otherwise determine an identifier for accessing the second MRN 614, 716, as described above. For example, in an embodiment, the resolver 1042 can send a query to a resolver service (not shown) to determine an identifier for the second MRN 614, 716 hosting a second MRS and representing the second metadata-schema domain. The query can include a service type identifying an MRS type and/or the identified metadata-schema domain described above. Based on the query, the resolver service can identify the second MRN 614, 716, and return an identifier of the second MRN 614, 716 in a response message. The message generator 1010 can use the identifier of the second MRN 614, 716 to route the second message to the second MRN 614, 716.

In an embodiment, the routing layer component 902 in the sending MRN 610, 710 can be configured to receive a metadata access response 675, 775 from the second MRN 614, 716. The message generator component 1010 can be invoked to generate a second metadata access response 680, 780 including or otherwise based on the response 675, 775 from the second MRN 614, 716, and send the second metadata access response 680, 780 to the client node 602, 702.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for providing access to metadata of a network accessible resource, the method comprising:
receiving request information identifying a matching condition and identifying a metadata-schema domain in a metadata-schema domain space, wherein the metadata-schema domain includes a network domain of a schema provider node providing access to a metadata-schema defining metadata of a network accessible resource;
generating a metadata access request identifying the metadata-schema domain and identifying the matching condition; and
sending, based on the identified metadata-schema domain, the metadata access request to a metadata repository node (MRN) representing a metadata-schema domain at least partially including the metadata-schema domain identified in the metadata access request, wherein the MRN is configured to maintain an association between metadata and a network accessible resource, and is configured to process the request to provide access to at least a portion of the association based on an evaluation of the matching condition,
wherein at least one of the preceding actions is performed on at least one electronic hardware component.

2. The method of claim 1 wherein receiving the request information comprises receiving a schema locator including a metadata-schema domain identifier.

3. The method of claim 2 further including receiving a Uniform Resource Name (URN) identifying the metadata schema, and determining the schema locator based on the URN.

4. The method of claim 2 wherein the schema locator is a Uniform Resource Locator (URL) of the metadata-schema, and the metadata access request includes at least a portion of the URL.

5. The method of claim 1 wherein sending the metadata access request to the MRN includes determining a network address of a node configured to route the request based on the identified metadata-schema domain to the MRN representing the metadata-schema domain at least partially including the identified metadata-schema domain, wherein the determined network address is at least one of provided in configuration data of a sending node, received from user input, received in a resource, received when the metadata access request is generated, received from a remote node in response to a request, and generated based on at least one of a configured template, an identifier of a metadata schema, an identifier of a resource, and an identifier of the metadata.

6. The method of claim 1 further comprising receiving, from the MRN, a metadata access response in response to the metadata access request, the response including an accessor for accessing the metadata and the network accessible resource in the accessed association.

7. A method for providing access to metadata of a network accessible resource, the method comprising:
receiving, by a metadata repository node (MRN) representing a metadata-schema domain in a metadata-schema domain space, a metadata access request identifying a matching condition and identifying a metadata-schema domain, wherein the identified metadata-schema domain includes a network domain of a schema provider node providing access to a metadata-schema defining metadata of a network accessible resource;
determining that the metadata-schema domain identified in the metadata access request is at least partially included in the metadata-schema domain represented by the MRN; and
processing, by the MRN, the metadata access request in response to determining that the identified metadata-schema domain is at least partially included in the metadata-schema domain represented by the MRN, the processing including providing access to at least a portion of an association between metadata and the network accessible resource based on an evaluation of the matching condition,
wherein at least one of the preceding actions is performed on at least one electronic hardware component.

8. The method of claim 7 wherein the metadata-schema domain in the metadata access request is identified by a metadata-schema domain identifier that comprises one of a name in a naming domain space and a subnet identifier in a network address domain space, and wherein determining whether the metadata-schema domain identified in the metadata access request is at least partially included in the metadata-schema domain represented by the MRN includes mapping the metadata-schema domain identifier in the metadata access request to a domain space corresponding to the domain space of a metadata-schema domain identifier of the metadata-schema domain represented by the MRN, and comparing the mapped metadata-schema domain identifier in the metadata access request to the metadata-schema domain identifier of the metadata-schema domain represented by the MRN.

9. The method of claim 7 wherein processing the metadata access request includes at least one of locating a storage area for storing a new association between metadata and the network accessible resource, reading the metadata, updating at least a portion of the metadata, and deleting at least a portion of the metadata.

10. The method of claim 7 wherein the MRN is configured to maintain a plurality of records representing an association between metadata and the network accessible resource, and wherein processing the metadata access request includes determining at least one record matching the matching condition, and retrieving an accessor associated with the at least one matching record, the accessor for accessing the metadata and the network accessible resource in the accessed association.

11. The method of claim 10 wherein the accessor includes at least one of the metadata associated with the at least one matching record and a metadata locator for accessing the metadata associated with the at least one matching record.

12. The method of claim 7 wherein processing the metadata access request includes generating a metadata access response including an accessor for accessing the metadata and the network accessible resource, and sending the response to a receiving node, wherein the receiving node is a node from which the metadata access request was sent.

13. The method of claim 7 wherein when the metadata-schema domain identified in the metadata access request is determined not to be at least partially included in the metadata-schema domain represented by the MRN, the method further includes generating a message including at least a portion of the metadata access request, and sending the message for routing based on the identified metadata-schema domain to a second MRN representing a second metadata-schema domain.

14. The method of claim 13 wherein sending the message for routing to the second MRN includes determining an address of a node configured to route the message to the second MRN, wherein the determined address is at least one of provided in configuration data of the sending MRN, received with the metadata access request, received from a resolver service in response to a request, and generated based on identifiers of at least one of the metadata schema, the resource, and the metadata.

15. A computer readable medium storing a computer program, executable by a machine, for providing access to metadata of a network accessible resource, the computer program including executable instructions for:
receiving request information identifying a matching condition and identifying a metadata-schema domain in a metadata-schema domain space, wherein the metadata-schema domain includes a network domain of a schema provider node providing access to a schema defining metadata of a network accessible resource;
generating a metadata access request identifying the metadata-schema domain and identifying the matching condition; and
sending, based on the identified metadata-schema domain, the metadata access request to a metadata repository node (MRN) representing a metadata-schema domain at least partially including the metadata-schema domain identified in the metadata access request, wherein the MRN is configured to maintain an association between metadata and a network accessible resource, and is configured to process the request to provide access to at least a portion of the association based on an evaluation of the matching condition.

16. A computer readable medium storing a computer program, executable by a machine, for providing access to metadata of a network accessible resource, the computer program including executable instructions for:
receiving, by a metadata repository node (MRN) representing a metadata-schema domain in a metadata-schema domain space, a metadata access request identifying a matching condition and identifying a metadata-schema domain that includes a network domain of a schema provider node providing access to a metadata schema defining metadata of a network accessible resource;
determining that the metadata-schema domain identified in the metadata access request is at least partially included in the metadata-schema domain represented by the MRN; and
processing, by the MRN, the metadata access request in response to determining that the identified metadata-schema domain is at least partially included in the metadata-schema domain represented by the MRN, the processing including providing access to at least a portion of an association between metadata and the network accessible resource based on an evaluation of the matching condition.

17. A system for providing access to metadata of a network accessible resource, the system comprising:
means for receiving request information identifying a matching condition and identifying a metadata-schema domain in a metadata-schema domain space, wherein the metadata-schema domain includes a network domain of a schema provider node providing access to a schema defining metadata of a network accessible resource;
means for generating a metadata access request identifying the metadata-schema domain and identifying the matching condition; and
means for sending, based on the identified metadata-schema domain, the metadata access request to a metadata repository node (MRN) representing a metadata-schema domain at least partially including the metadata-schema domain identified in the metadata access request, wherein the MRN is configured to maintain an association between metadata and a network accessible resource, and is configured to process the request to provide access to at least a portion of the association based on an evaluation of the matching condition,
wherein at least one of the means includes at least one electronic hardware component.

18. A system for providing access to metadata of a network accessible resource, the system comprising:
means for receiving, by a metadata repository node (MRN) representing a metadata-schema domain in a metadata-schema domain space, a metadata access request identifying a matching condition and identifying a metadata-schema domain that includes a network domain of a schema provider node providing access to a metadata schema defining metadata of a network accessible resource;
means for determining that the metadata-schema domain identified in the metadata access request is at least partially included in the metadata-schema domain represented by the MRN; and
means for processing, by the MRN, the metadata access request in response to determining that the identified metadata-schema domain is at least partially included in the metadata-schema domain represented by the MRN, the processing including providing access to at least a portion of an association between metadata and the network accessible resource based on an evaluation of the matching condition,
wherein at least one of the means includes at least one electronic hardware component.

19. A system for providing access to metadata of a network accessible resource, the system comprising system components including:
a content handler component configured to receive request information identifying a matching condition and identifying a metadata-schema domain in a metadata-schema domain space, wherein the metadata-schema domain includes a network domain of a schema provider node providing access to a schema defining metadata of a network accessible resource;
a message formatter component configured to generate a metadata access request identifying the metadata-schema domain and identifying the matching condition; and
a content manager component configured to send, based on the identified metadata-schema domain, the metadata access request to a metadata repository node (MRN) representing a metadata-schema domain at least partially including the metadata-schema domain identified in the metadata access request, wherein the MRN is configured to maintain an association between metadata and a network accessible resource, and is configured to process the request to provide access to at least a portion of the association based on an evaluation of the matching condition,
wherein at least one of the system components includes at least one electronic hardware component.

20. The system of claim 19 wherein the content handler component is configured to receive a schema locator including a metadata-schema domain identifier.

21. The system of claim 20 wherein the content handler component is configured to receive a Uniform Resource Name (URN) identifying the metadata schema, and to determine the schema locator based on the URN.

22. The system of claim 20 wherein the schema locator is a Uniform Resource Locator (URL) of the metadata schema, and the metadata access request includes at least a portion of the URL.

23. The system of claim 19 wherein the content manager component is configured to determine a network address of a node configured to route the request based on the identified metadata-schema domain to the MRN representing the metadata-schema domain at least partially including the identified metadata-schema domain, wherein the determined network address is at least one of provided in configuration data of a sending node, received from user input, received in a resource, received when the access request is generated, received from a remote node in response to a request, and generated based on at least one of a configured template, an identifier of a metadata schema, an identifier of a resource, and an identifier of the metadata.

24. The system of claim 19 wherein the content handler component is further configured to receive, from the MRN, a metadata access response in response to the metadata access request, the response including an accessor for accessing the metadata and the network accessible resource in the accessed association.

25. A system for providing access to metadata of a network accessible resource, the system comprising system components including:
a routing layer component in a metadata repository node (MRN) representing a metadata-schema domain in a metadata-schema domain space, the routing layer configured to receive a metadata access request identifying a matching condition and identifying a metadata-schema domain that includes a network domain of a schema provider node providing access to a metadata schema defining metadata of a network accessible resource;
a domain manager component configured to determine that the metadata-schema domain identified in the metadata access request is at least partially included in the metadata-schema domain represented by the MRN; and
a processing agent component in the MRN configured to process the metadata access request in response to determining that the identified metadata-schema domain is at least partially included in the metadata-schema domain represented by the MRN, the processing including providing access to at least a portion of an association between metadata and the network accessible resource based on an evaluation of the matching condition,
wherein at least one of the system components includes at least one electronic hardware component.

26. The system of claim 25 wherein the metadata-schema domain in the metadata access request is identified by a metadata-schema domain identifier that comprises one of a name in a naming domain space and a subnet identifier in a network address domain space, and wherein the domain manager component is configured to map the metadata-schema domain identifier in the metadata access request to a domain space corresponding to the domain space of a metadata-schema domain identifier of the metadata-schema domain represented by the MRN, and to compare the mapped metadata-schema domain identifier in the metadata access request to the metadata-schema domain identifier of the metadata-schema domain represented by the MRN.

27. The system of claim 25 wherein the processing agent component is configured to at least one of locate a storage area for storing a new association between metadata and the network accessible resource, read the metadata, update at least a portion of the metadata, and delete at least a portion of the metadata.

28. The system of claim 25 wherein the MRN is configured to maintain a plurality of records representing an association between metadata and the network accessible resource, and wherein the processing agent component is configured to determine at least one record matching the matching condition, and to retrieve an accessor associated with the at least one matching record, the accessor for accessing the metadata and the network accessible resource in the accessed association.

29. The system of claim 28 wherein the accessor includes at least one of the metadata associated with the at least one matching record and a metadata locator for accessing the metadata associated with the at least one matching record.

30. The system of claim 25 further comprising a message generator component configured to generate a metadata access response including an accessor for accessing the metadata and the network accessible resource, and sending the response to a receiving node, wherein the receiving node is a node from which the metadata access request was sent.

31. The system of claim 25 further comprising a message generator component configured to generate a message including at least a portion of the metadata access request when the metadata-schema domain identified in the metadata access request is determined not to be at least partially included in the metadata-schema domain represented by the MRN, and to send the message for routing based on the identified metadata-schema domain to a second MRN representing a second metadata-schema domain.

32. The system of claim 31 wherein the message generator component is configured to determine an address of a node configured to route the message to the second MRN, wherein the determined address is at least one of provided in configuration data of the sending MRN, received with the request, received from a resolver service in response to a request, and generated based on identifiers of at least one of the metadata schema, the resource, and the metadata.
